(19) United States
(12) Patent Application Publication
(10) Pub. No.: US 2016/0115292 A1
(43) Pub. Date: Apr. 28, 2016

(54) SEPARATION METHOD AND SEPARATION DEVICE USED THEREIN

(71) Applicant: Daiki Co., Ltd., Tokyo (JP)

(72) Inventors: Hiroshi Ito, Tokyo (JP); Junji Yoshinaga, Tokyo (JP)

(73) Assignee: Daiki Co., Ltd., Tokyo (JP)

(21) Appl. No.: 14/989,509

(22) Filed: Jan. 6, 2016

Related U.S. Application Data
(63) Continuation of application No. PCT/JP2013/072767, filed on Aug. 26, 2013.

(51) Int. Cl. C08J 11/06; B29B 17/02; B09B 3/00

(52) U.S. Cl. CPC C08J 11/06; B09B 3/0083; B29B 17/02; C08J 2323/06; C08J 2323/12; C08J 2367/02; B29B 2017/0255; B29K 2105/26

(57) ABSTRACT

Provided are a separation method and a separation device used therein with which plastic and aluminum can be separated. The separation method includes a first heating step, and a first heat insulation step. In the first heating step, a processing target, which is accommodated in a container and contains aluminum and one or more types of plastic, is heated to a first temperature. The first temperature is a temperature that is less than the melting point of the aluminum and is greater than or equal to the melting point of at least one type of the plastic. Thus, the at least one type of plastic is melted. In the subsequent first heat insulation step, the processing target is kept at the first temperature. The heat insulation is continued until the aluminum is precipitated in the container and separated from the melted plastic.

### CROSS REFERENCE TO RELATED APPLICATION

This is a Continuation of International Application No. PCT/JP2013/072767 filed Aug. 26, 2013. The contents of this application are hereby incorporated by reference in their entirety.

### TECHNICAL FIELD

The present invention relates to a separation method and a separation device used therein.

### BACKGROUND ART

In recent years, the need to recycle resources has been increasing, and among resources, it is important to recycle plastic. With regard to recycling of plastic, various techniques have been proposed (Patent Literature 1, for example).

### CITATION LIST

### Patent Literature

[PLT 1] JP 2008-156532A

### SUMMARY OF INVENTION

### Technical Problem

Incidentally, among plastics, there are plastics to which aluminum adheres, such as an aluminized film. In order to recycle such plastic, it is necessary to separate the plastic and the aluminum.

### Solution to Problem

The present invention has been made in view of the above-described issues, and an object thereof is to provide a separation method and a separation device used therein with which plastic and aluminum can be separated.

A separation method according to the present invention includes a first heating step of heating a processing target, which contains aluminum and one or more types of plastic and is accommodated in a first container that accommodates the processing target, to a first temperature, which is a temperature that is less than a melting point of the aluminum and is greater than or equal to a melting point of at least one type of the plastic, so as to melt the at least one type of the plastic, and a first heat insulation step of keeping the processing target accommodated in the first container at the first temperature until the aluminum is precipitated in the first container and separated from the plastic melted in the first heating step.

In the separation method, the processing target is heated to the first temperature in the first heating step. The first temperature is a temperature that is less than the melting point of aluminum and is greater than or equal to the melting point of at least one type of plastic. Accordingly, the at least one type of plastic, that is, plastic having a melting point that is less than or equal to the first temperature is melted. Moreover, the processing target is kept at the first temperature in the first heat insulation step. Accordingly, the state that the plastic is melted is maintained. The heat insulation is continued until the aluminum is precipitated in the first container and separated from the melted plastic. In such a way, the aluminum and the melted plastic are separated.

Also, a separation device according to the present invention is used in the separation method, and includes the first container, a first heating means for heating the processing target accommodated in the first container to the first temperature, and a first heat insulation means for keeping the processing target accommodated in the first container at the first temperature.

In the separation device, the processing target is heated by the first heating means to the first temperature. The first temperature is a temperature that is less than the melting point of aluminum and is greater than or equal to the melting point of at least one type of plastic. Accordingly, the at least one type of plastic, that is, plastic having a melting point that is less than or equal to the first temperature is melted. Moreover, the processing target is kept at the first temperature by the first heat insulation means. Accordingly, the state that the plastic is melted is maintained. The heat insulation is continued until the aluminum is precipitated in the first container and separated from the melted plastic. In such a way, the aluminum and the melted plastic are separated.

According to the present invention, a separation method and a separation device used therein with which plastic and aluminum can be separated are realized.

### BRIEF DESCRIPTION OF DRAWINGS

FIG. 1 is a configuration diagram showing an embodiment of a separation device according to the present invention.

FIG. 2 is a cross-sectional view showing a separation unit 20 in the separation device of FIG. 1.

FIG. 3 is a plan view showing the separation unit 20 in the separation device of FIG. 1.

FIG. 4 is a cross-sectional view showing a separation unit 40 in the separation device of FIG. 1.

FIG. 5 is a plan view showing the separation unit 40 in the separation device of FIG. 1.

FIG. 6 is a cross-sectional view for illustrating operations of the separation device of FIG. 1.

FIG. 7 is a cross-sectional view for illustrating operations of the separation device of FIG. 1.

FIG. 8 is a cross-sectional view for illustrating operations of the separation device of FIG. 1.

FIG. 9 is a cross-sectional view for illustrating operations of the separation device of FIG. 1.

### DESCRIPTION OF EMBODIMENTS

Hereinafter, an embodiment of the present invention will be described in detail with reference to drawings. Note that in the description of the drawings, like elements are denoted by like reference numerals and redundant descriptions are omitted.

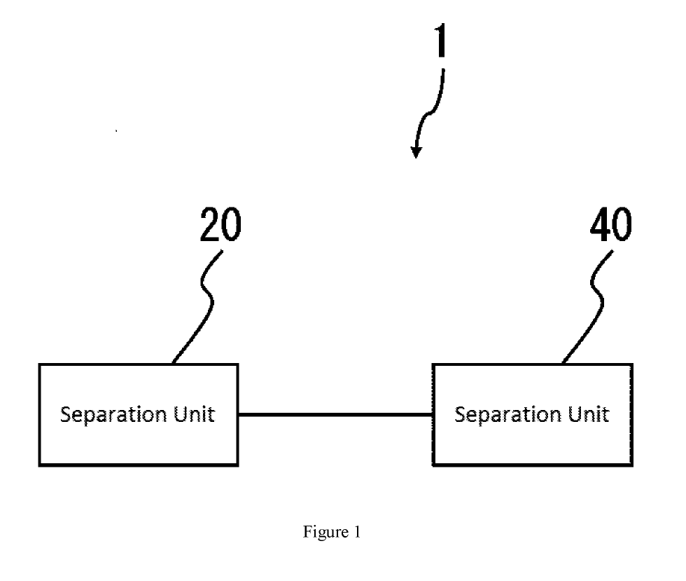

FIG. 1 is a configuration diagram showing an embodiment of a separation device according to the present invention. A separation device 1 is for separating aluminum and plastic by processing a processing target containing aluminum and one or more types of plastic, and extracting plastic from the processing target. The processing target is an aluminized film obtained by vapor-depositing aluminum on plastic, for example. In the present embodiment, the processing target contains three types of plastic, namely, polypropylene (PP), polyethylene (PE), and polyethylene terephthalate (PET). The separation device 1 includes a separation unit 20, and a separation unit 40.

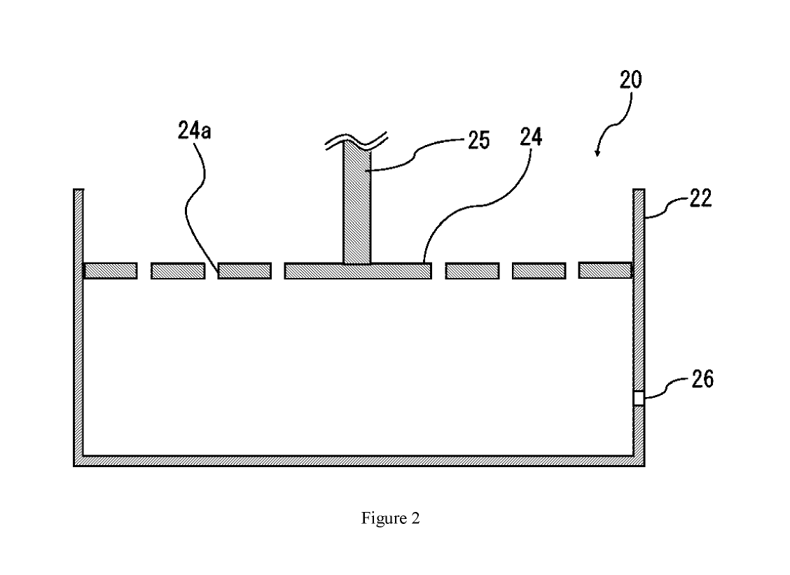

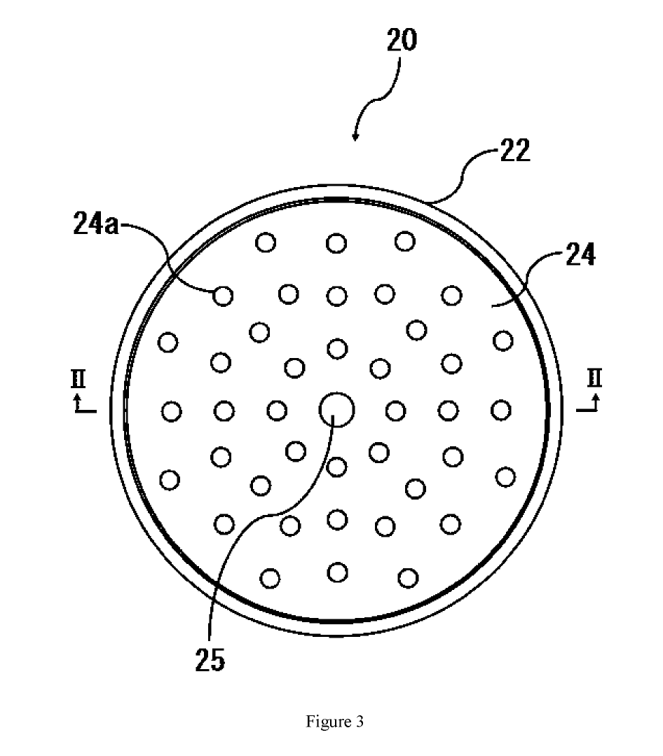

FIG. 2 is a cross-sectional view showing the separation unit 20. Also, FIG. 3 is a plan view showing the separation unit 20. FIG. 2 shows a cross-section taken along line II-II in FIG. 3. The separation unit 20 includes a container 22 (first container) that accommodates the processing target, and a pressing member 24 (first pressing member).

The container 22 has a heating means not shown, namely a heating means (first heating means) for heating the processing target accommodated in the container 22 to a first temperature. The first temperature is a temperature that is less than the melting point of aluminum (approximately 660° C.) and is greater than or equal to the melting point of at least one type of plastic. The first temperature is a temperature at which plastic to be separated and extracted does not burn. The first temperature of the present embodiment is 180° C. or greater and 220° C. or less. Melting points of PP, PE, and PET are respectively approximately 180° C., approximately 130° C., and approximately 270° C., and thus the first temperature is a temperature that is greater than or equal to the melting points of PP and PE, and that is less than the melting point of PET. Therefore, among PP, PE, and PET, and aluminum included in the processing target, only PP and PE are melted by being heated to the first temperature.

Also, the container 22 has a heat insulation means not shown, namely a heat insulation means (first heat insulation means) for keeping the processing target accommodated in the container 22 at the first temperature. Note that the first temperature of the present embodiment is 180° C. or greater and 220° C. or less as described above, but the first temperature in the heating and the first temperature in the heat insulation are not necessarily identical as long as both of the first temperatures are within the above temperature range. An electric tank (electric furnace) can be used as the container 22, for example.

The pressing member 24 separates aluminum and melted plastic (PP and PE in the present embodiment) by pressing the processing target accommodated in the container 22. Specifically, the pressing member 24 has hole portions 24a, and allows only the melted plastic to pass through the hole portions 24a when pressing the processing target, thereby separating the plastic and aluminum. The hole portions 24a have a size and shape that allow melted plastic to pass through but do not allow unmelted plastic or aluminum to pass through. The shape of the hole portions 24a is circular in plan view in the present embodiment. The hole portions 24a are provided so as to be opened and closed.

As shown in FIG. 3, the container 22 and the pressing member 24 are circular in plan view in the present embodiment. In other words, the container 22 is a container having a cylindrical side surface, and the pressing member 24 is a disk-shaped member. The outer diameter of the pressing member 24 is substantially equal to the inner diameter of the container 22. The pressing member 24 is provided slidably along the inner circumferential surface of the container 22. A shaft portion 25 is attached to the central portion of the pressing member 24. By applying force to the shaft portion 25, the pressing member 24 can be pressed so as to approach the bottom surface of the container 22.

A discharging outlet 26 (first discharging outlet) is provided to penetrate the side surface of the container 22. The discharging outlet 26 is for discharging plastic that has been separated from precipitated aluminum, that is, for discharging melted plastic to the outside of the container 22. The discharging outlet 26 is provided so as to be opened and closed. The discharging outlet 26 is closed, except for when discharging melted plastic.

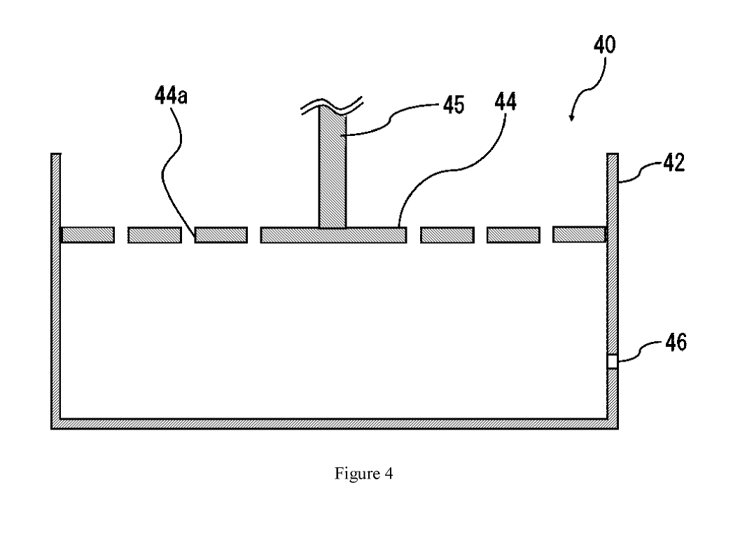

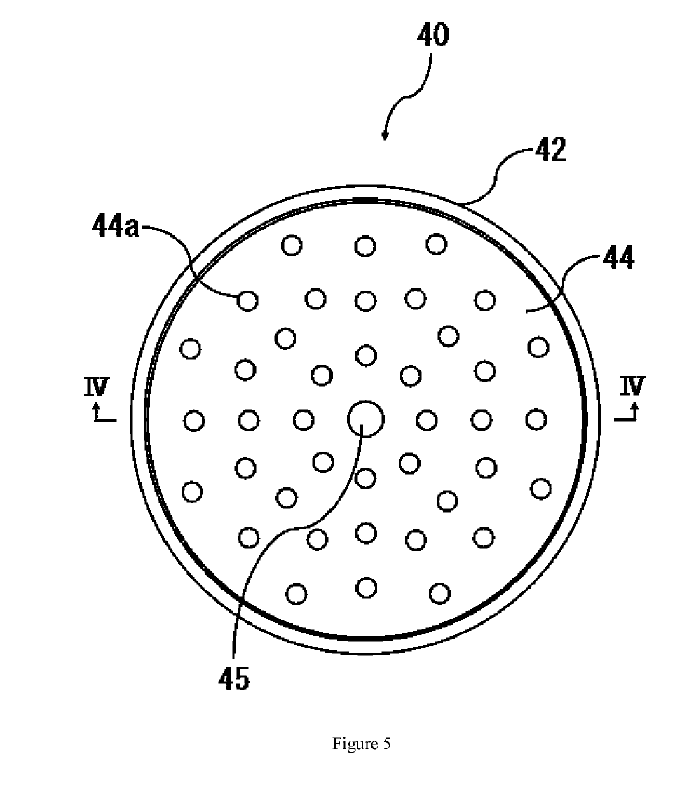

FIG. 4 is a cross-sectional view showing the separation unit 40. Also, FIG. 5 is a plan view showing the separation unit 40. FIG. 4 shows a cross-section taken along line IV-IV in FIG. 5. The separation unit 40 includes a container 42 (second container) that accommodates the processing target from which the plastic melted in the container 22 has been separated, and a pressing member 44 (second pressing member).

The container 42 has a heating means not shown, namely a heating means (second heating means) for heating the processing target accommodated in the container 42 to a second temperature. The second temperature is a temperature that is less than the melting point of aluminum (approximately 660° C.) and is greater than or equal to the melting point of at least one type of plastic that has not been melted in the container 22. In the present embodiment, only PET has not been melted in the container 22, and thus the second temperature is greater than or equal to the melting point of PET (approximately 270° C.). The second temperature is a temperature at which plastic to be separated and extracted does not burn. The second temperature of the present embodiment is 270° C. or greater and 310° C. or less. Therefore, among the PET and aluminum included in the processing target, only the PET is melted by being heated to the second temperature.

Also, the container 42 has a heat insulation means not shown, namely a heat insulation means (second heat insulation means) for keeping the processing target accommodated in the container 42 at the second temperature. The heat insulation is continued until the aluminum is precipitated in the container 42 and separated from the melted plastic. Note that the second temperature of the present embodiment is 270° C. or greater and 310° C. or less as described above, but the second temperature in the heating and the second temperature in the heat insulation are not necessarily identical as long as both of the second temperatures are within the above temperature range. An electric tank (electric furnace) can be used as the container 42, for example.

The pressing member 44 separates aluminum and melted plastic (PET in the present embodiment) by pressing the processing target accommodated in the container 42. Specifically, the pressing member 44 has hole portions 44a, and allows only the melted plastic to pass through the hole portions 44a when pressing the processing target, thereby separating the plastic and aluminum. The hole portions 44a have a size and shape that allow melted plastic to pass through but do not allow unmelted plastic or aluminum to pass through. The shape of the hole portions 44a is circular in plan view in the present embodiment. The hole portions 44a are provided so as to be opened and closed.

As shown in FIG. 5, the container 42 and the pressing member 44 are circular in plan view in the present embodiment. In other words, the container 42 is a container having a cylindrical side surface, and the pressing member 44 is a disk-shaped member. The outer diameter of the pressing member 44 is substantially equal to the inner diameter of the container 42. The pressing member 44 is provided slidably along the inner circumferential surface of the container 42. A shaft portion 45 is attached to the central portion of the pressing member 44. By applying force to the shaft portion 45, the pressing member 44 can be pressed so as to approach the bottom surface of the container 42. Note that the container 42 and the pressing member 44 are smaller than the above-described container 22 and the pressing member 24.

A discharging outlet 46 (second discharging outlet) is provided to penetrate the side surface of the container 42. The discharging outlet 46 is for discharging plastic that has been separated from precipitated aluminum, that is, for discharging melted plastic to the outside of the container 42. The discharging outlet 46 is provided so as to be opened and closed. The discharging outlet 46 is closed, except for when discharging melted plastic.

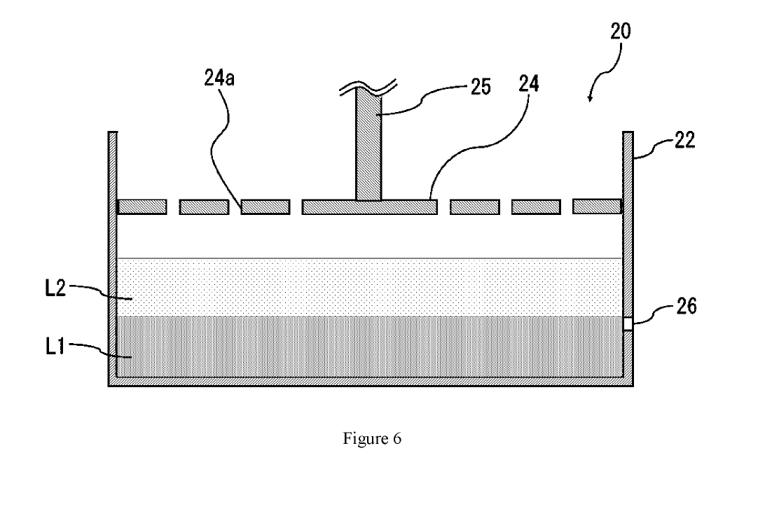

Next, the operations of the separation device 1 will be described as an embodiment of the separation method according to the present invention, with reference to FIGS. 6 to 9. First, the processing target in the container 22 is heated to the first temperature by the first heating means so as to melt PP and PE (first heating step). After that, the processing target is kept at the first temperature by the first heat insulation means (first heat insulation step). The heat insulation is continued until the aluminum is precipitated in the container 22 and separated from the melted plastic. The heat insulation time is 2 to 6 hours, for example. During this time, the processing target may be stirred. Accordingly, PET and aluminum are precipitated, and as shown in FIG. 6, the processing target is separated into a layer L1 constituted mainly by aluminum and PET and a layer L2 constituted mainly by PP and PE.

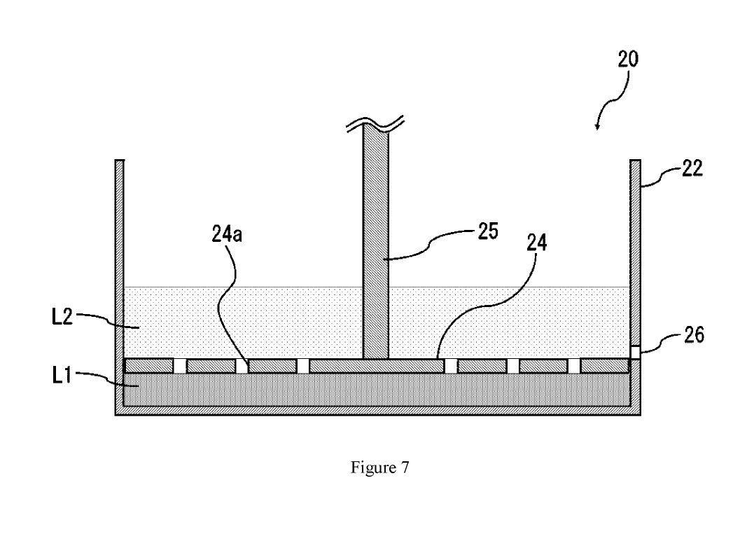

Next, as shown in FIG. 7, the processing target in the state of being kept at the first temperature is pressed by the pressing member 24. At this time, the melted PP and PE pass through the hole portions 24a of the pressing member 24. Accordingly, aluminum and PET remain on the pressing surface side of the pressing member 24, whereas PP and PE are extracted on the opposite side. In this manner, separation of aluminum (and PET, which is unmelted plastic) from PP and PE, which are melted plastic is facilitated (first pressing step). Thereafter, in order to prevent PP and PE from returning from the layer L2 to the layer L1 through the hole portions 24a, it is preferable to close the hole portions 24a.

By opening the discharging outlet 26 in this state, PP and PE separated from aluminum are discharged to the outside of the container 22 (first discharging step). Also, the aluminum and PET are discharged to the outside of the container 22 through a discharging outlet (not shown), and are transferred to the container 42 of the separation unit 40. At this time, moisture may be removed from the aluminum and PET by means of dehydration through centrifugation or drying with warm air or the like, as needed.

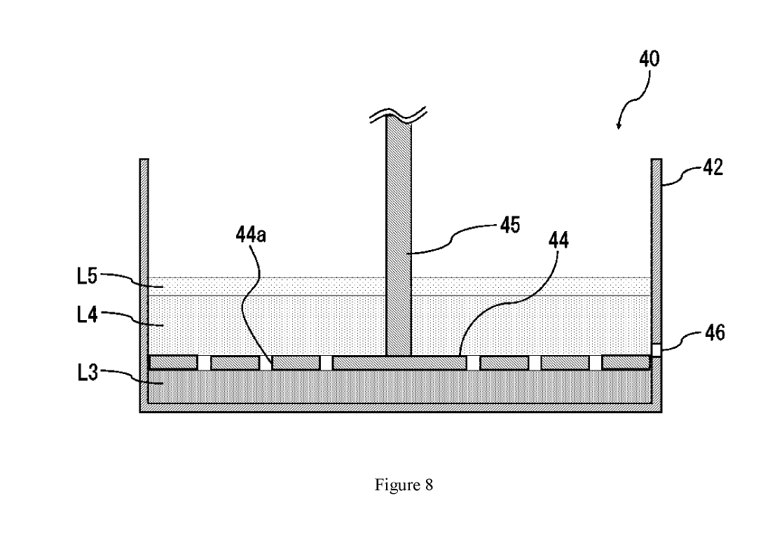

Next, the processing target, from which PP and PE have been separated, in the container 42 is heated to the second temperature by the second heating means so as to melt PET (second heating step). After that, the processing target is kept at the second temperature by the second heat insulation means (second heat insulation step). The heat insulation is continued until the aluminum is precipitated in the container 42 and separated from the melted plastic. The heat insulation time is 2 to 6 hours, for example. During this time, the processing target may be stirred. Accordingly, aluminum is precipitated, and as shown in FIG. 8, the processing target is separated into a layer L3 constituted mainly by aluminum and a layer L4 constituted mainly by PET.

Note that although PP and PE that were not separated in the separation unit 20 are present in the container 42, the PP and PE are separated into a layer different from that of PET. Specifically, in contrast to the specific gravity of PET being approximately 1.29 to 1.4, the specific gravity of PP is approximately 0.9, the specific gravity of PE having a high density is approximately 0.95 to 0.97, and the specific gravity of PE having a low density is approximately 0.92 to 0.93, and therefore the processing target is separated into the layer L4 constituted mainly by PET and the layer L5 constituted mainly by PP and PE due to a difference in specific gravity.

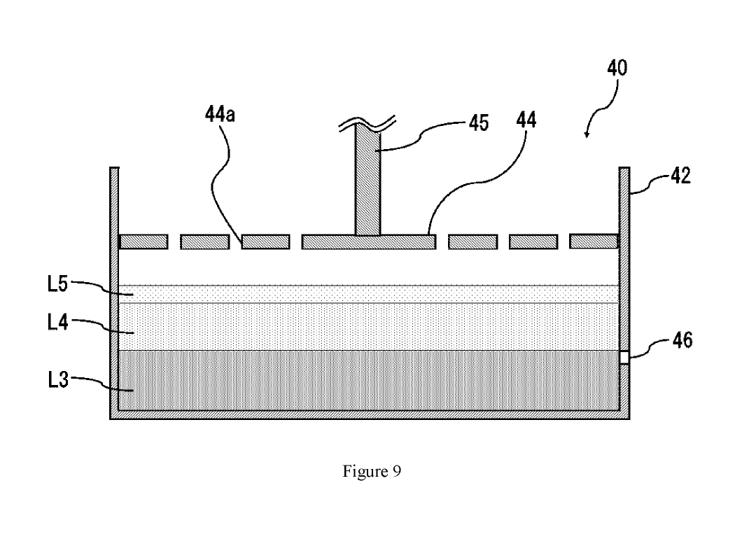

Next, as shown in FIG. 9, the processing target in the state of being kept at the second temperature is pressed by the pressing member 44. At this time, the melted PET (and PP and PE) passes through the hole portions 44a of the pressing member 44. Accordingly, aluminum remains on the pressing surface side of the pressing member 44, whereas PET is extracted on the opposite side. In this manner, separation of aluminum from PET, which is melted plastic is facilitated (second pressing step). Thereafter, in order to prevent PET from returning from the layer L4 to the layer L3 through the hole portions 44a, it is preferable to close the hole portions 44a.

By opening the discharging outlet 46 in this state, PET separated from aluminum is discharged to the outside of the container 42 (second discharging step). Also, the aluminum is discharged to the outside of the container 42 through a discharging outlet (not shown), as needed.

Effects of the present embodiment will be described. The processing target is heated to the first temperature in the separation unit 20. Thus, PP and PE, that is, plastics having melting points that are less than or equal to the first temperature are melted. Moreover, the processing target is kept at the first temperature. Accordingly, the state that the PP and PE are melted is maintained. The heat insulation is continued until the aluminum is precipitated in the container 22 and separated from the PP and PE. In such a way, the aluminum, and the PP and PE are separated.

Conventionally, it has been difficult to separate a highly-pure plastic from an aluminized film, but the separation technique according to the present embodiment can be used practically. The obtained PP and PE can be reused as a plastic material. Although PP and PE can be reused as a mixture, if necessary, PP and PE may be separated.

Moreover, the processing target in the state of being kept at the first temperature is pressed by the pressing member 24 in the present embodiment. At this time, since the pressing member 24 are provided with the hole portions 24a, the melted plastic (PP and PE) passes through the hole portions 24a. Accordingly, aluminum (and PET, which is unmelted plastic) remains on the pressing surface side of the pressing member 24, whereas PP and PE are extracted on the opposite side. By pressing the processing target with the pressing member 24 in this way, aluminum and PET can be concentrated on the pressing surface side of the pressing member 24, and PP and PE can be concentrated on the opposite side. Thus, more highly-pure

PP and PE can be obtained.

The hole portions 24a of the pressing member 24 can be opened and closed. Therefore, by closing the hole portions 24a after the processing target is pressed by the pressing member 24, it is possible to prevent PP and PE from returning to the pressing surface side from the side opposite to the pressing surface.

The pressing member 24 is provided slidably along the inner circumferential surface of the container 22. That is, the pressing surface side of the pressing member 24 and the side opposite thereto are in communication with each other through only the hole portions 24a. Therefore, it is possible to prevent the unmelted plastic (PET) and aluminum from moving to the side opposite to the pressing surface of the pressing member 24.

The discharging outlet 26 is provided in the side surface of the container 22. Accordingly, the separated plastic (PP and PE) can be easily brought out from the container 22.

Also, not only the separation unit 20 but also the separation unit 40 are provided in the present embodiment. The processing target is heated to the second temperature in the separation unit 40. Thus, PET, that is, plastic having a melting point that is less than or equal to the second temperature is melted. Moreover, the processing target is kept at the second temperature. Accordingly, the state that the PET is melted is maintained. The heat insulation is continued until the aluminum is precipitated in the container 42 and separated from the PET. In such a way, the aluminum and the PET are separated. The obtained PET can be reused as a plastic material. Also, the aluminum separated from the plastic can be reused.

Moreover, the processing target in the state of being kept at the second temperature is pressed by the pressing member 44 in the present embodiment. At this time, since the pressing member 44 are provided with the hole portions 44a, the melted plastic (PET) passes through the hole portions 44a. Accordingly, aluminum remains on the pressing surface side of the pressing member 44, whereas PET is extracted on the opposite side. By pressing the processing target with the pressing member 44 in this way, aluminum can be concentrated on the pressing surface side of the pressing member 44, and PET can be concentrated on the opposite side. Thus, more highly-pure PET and aluminum can be obtained.

The hole portions 44a of the pressing member 44 can be opened and closed. Therefore, by closing the hole portions 44a after the processing target is pressed by the pressing member 44, it is possible to prevent PET from returning to the pressing surface side from the side opposite to the pressing surface.

The pressing member 44 is provided slidably along the inner circumferential surface of the container 42. That is, the pressing surface side of the pressing member 44 and the side opposite thereto are in communication with each other through only the hole portions 44a. Therefore, it is possible to prevent the aluminum from moving to the side opposite to the pressing surface of the pressing member 44.

A discharging outlet 46 is provided in the side surface of the container 42. Accordingly, the separated plastic (PET) can be easily brought out from the container 42.

The separation method and the separation device according to the present invention are not limited to the above-described embodiment, and various modifications can be made thereto. For example, a case where the processing target contains three types of plastic (PP, PE, and PET) has been described in the above-described embodiment. However, it is possible for the processing target to contain only one type of plastic. In such a case, the plastic can be separated by merely performing heating and separation one time each, and thus it is not necessary to provide the separation unit 40.

In general, the processing target may contain n types (n is an integer that is greater than or equal to 2) of plastic. In the case where the first temperature is set to a temperature that is greater than or equal to each melting point of m types (m is an integer that is greater than or equal to 1 and less than n) of plastic, and that is less than each melting point of (n-m) types of plastic, the m types of plastic are melted in the first heating step and are separated from aluminum in the first heat insulation step. In this case, the second temperature is a temperature that is less than the melting point of the aluminum and that is greater than or equal to the melting point of at least one of the (n-m) types of plastic. Note that a case of n=3 and m=2 has been described as an example in the above-described embodiment.

In the above-described embodiment, a case in which separation of plastic is performed three separate times has been described. However, separation of plastic may be performed three or more separate times. For example, in the case where the processing target contains three types of plastic that need to be separated and extracted individually, it is sufficient to perform separation three separate times.

In the above-described embodiment, an example was shown in which the first container (container 22) and the second container (container 42) are provided separately. However, the first and second containers may be the same container. That is, one container may be used as the first and second containers.

In the above-described embodiment, hole portions 24a that are circular in plan view have been described as an example. However, the hole portions 24a may have another shape (rectangular shape in plan view, for example). Also, the hole portion 24a may be formed by making substantially the entirety or a portion of the pressing member 24 a net-like shape. In other words, in this case, the meshes of the pressing member 24 correspond to the hole portions 24a. The same applies to the hole portions 44a.

In the above-described embodiment, an example was shown in which the pressing member 24 and the pressing member 44 are provided. However, the provision of the pressing member 24 and the pressing member 44 is not necessarily required. Therefore, the execution of the first and second pressing steps is also not necessarily required.

### LIST OF REFERENCE NUMERALS

1 Separation device

20 Separation unit

22 Container (first container)

24 Pressing member (first pressing member)

24a Hole portion

25 Shaft portion

26 Discharging outlet (first discharging outlet)

0 Separation unit

42 Container (second container)

44 Pressing member (second pressing member)

44a Hole portion

45 Shaft portion

46 Discharging outlet (second discharging outlet)

1. A separation method, comprising:
a first heating step of heating a processing target, which contains aluminum and one or more types of plastic and is accommodated in a first container that accommodates the processing target, to a first temperature, which is a temperature that is less than a melting point of the aluminum and is greater than or equal to a melting point of at least one type of the plastic, so as to melt the at least one type of the plastic; and
a first heat insulation step of keeping the processing target accommodated in the first container at the first temperature until the aluminum is precipitated in the first container and separated from the plastic melted in the first heating step.

2. The separation method according to claim 1, wherein
the processing target is stirred in the first heat insulation step.

3. The separation method according to claim 1, comprising
a first pressing step of pressing the processing target kept at the first temperature with a first pressing member having a hole portion that allows the plastic melted in the first heating step to pass through without allowing the aluminum to pass through.

4. The separation method according to claim 3, wherein
the hole portion of the first pressing member can be opened and closed.

5. The separation method according to claim 3, wherein
the first pressing member is provided slidably along an inner circumferential surface of the first container.

6. The separation method according to claim 1, comprising
a first discharging step of discharging the plastic that has been melted in the first heating step and has been separated from the aluminum in the first heat insulation step, through a first discharging outlet provided to penetrate a side surface of the first container, to an outside of the first container.

7. The separation method according to claim 1, wherein
the processing target contains n types (n is an integer that is greater than or equal to 2) of the plastic,
the first temperature is a temperature that is greater than or equal to each melting point of m types (m is an integer that is greater than or equal to 1 and less than n) of the plastic, and that is less than each melting point of (n-m) types of the plastic, and
the m types of the plastic are melted in the first heating step, and are separated from the aluminum in the first heat insulation step.

8. The separation method according to claim 7, comprising:
a second heating step of heating the processing target, from which the m types of the plastic have been separated, which is accommodated in a second container that accommodates the processing target to a second temperature, which is a temperature that is less than the melting point of the aluminum and is greater than or equal to the melting point of at least one of the (n-m) types of the plastic, so as to melt the at least one type of the plastic; and
a second heat insulation step of keeping the processing target accommodated in the second container at the second temperature until the aluminum is precipitated in the second container and separated from the plastic melted in the second heating step.

9. The separation method according to claim 8, wherein
the processing target is stirred in the second heat insulation step.

10. The separation method according to claim 8, comprising
a second pressing step of pressing the processing target kept at the second temperature with a second pressing member having a hole portion that allows the plastic melted in the second heating step to pass through without allowing the aluminum to pass through.

11. The separation method according to claim 10, wherein
the hole portion of the second pressing member can be opened and closed.

12. The separation method according to claim 10, wherein
the second pressing member is provided slidably along an inner circumferential surface of the second container.

13. The separation method according to claim 8, comprising
a second discharging step of discharging the plastic that has been melted in the second heating step and has been separated from the aluminum in the second heat insulation step, through a second discharging outlet provided to penetrate a side surface of the second container, to an outside of the second container.

14. The separation method according to claim 1, wherein
the processing target contains polypropylene, polyethylene, and polyethylene terephthalate as the plastic.

15. The separation method according to claim 1, wherein
the processing target is an aluminized film obtained by vapor-depositing the aluminum on the plastic.

16. A separation device used in the separation method according to claim 1, comprising:
the first container;
a first heating means for heating the processing target accommodated in the first container to the first temperature; and
a first heat insulation means for keeping the processing target accommodated in the first container at the first temperature.

17. A separation device used in the separation method according to claim 8, comprising:
the first container;
a first heating means for heating the processing target accommodated in the first container to the first temperature;
a first heat insulation means for keeping the processing target accommodated in the first container at the first temperature;
the second container;
a second heating means for heating the processing target accommodated in the second container to the second temperature; and
a second heat insulation means for keeping the processing target accommodated in the second container at the second temperature.
